(19) United States
(12) Patent Application Publication
(10) Pub. No.: US 2016/0210931 A1
(43) Pub. Date: Jul. 21, 2016

(54) DISPLAYING DEVICE AND ELECTRONIC DEVICE WITH THE SAME

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: JIN-WEI WANG, Wuhan (CN)

(21) Appl. No.: 14/614,865

(22) Filed: Feb. 5, 2015

(30) Foreign Application Priority Data
Jan. 19, 2015 (CN) 201510025005.4

(51) Int. Cl. G09G 5/00

(52) U.S. Cl. CPC G09G 5/00; G09G 2330/021

(57) ABSTRACT

Displaying device includes a control module, a power supply module and a displaying module coupled to the power supply module. The control module is used to receive a first signal to allow the power supply module for supplying power for the displaying module. The control module is also used to receive a second signal to allow the power supply module for stopping supplying power for the displaying module. The disclosure further offers an electronic device with the displaying device.

### FIELD

The subject matter herein generally relates to a displaying device and an electronic device with the displaying device.

### BACKGROUND

Portable devices, such as notebook computers, are becoming increasingly popular among college students, businesspeople, writers, and others who require portable word-processing, e-mail, and computer graphics capabilities. In particular, notebook-sized computers, commonly known as “notebook computers”, are becoming increasingly popular because their small size and light weight making them portable and convenient to use.

### BRIEF DESCRIPTION OF THE DRAWINGS

Implementations of the present technology will now be described, by way of example only, with reference to the attached figures.

FIG. 1 is an isometric view of an embodiment of an electronic device.

FIG. 2 is a block diagram of one embodiment of function modules of the electronic device of FIG. 1.

FIG. 3 is a circuit view of one embodiment of a displaying device of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a displaying device. The displaying device includes a control module, a power supply module and a display module coupled to the power supply module. The control module is used to receive a first signal to allow the power supply module to supply power to the display module. The control module is also used to receive a second signal to allow the power supply module to stop supplying power for the display module.

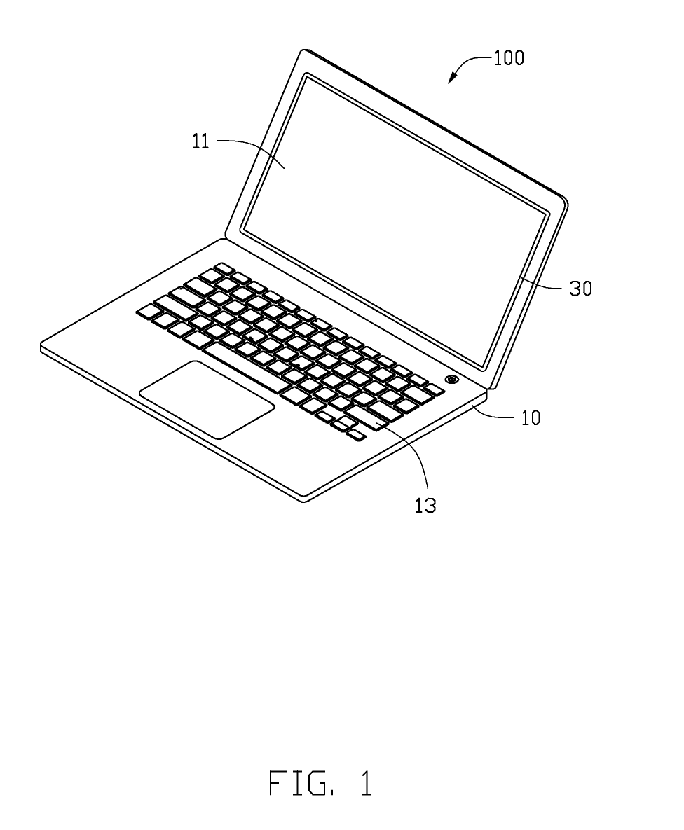

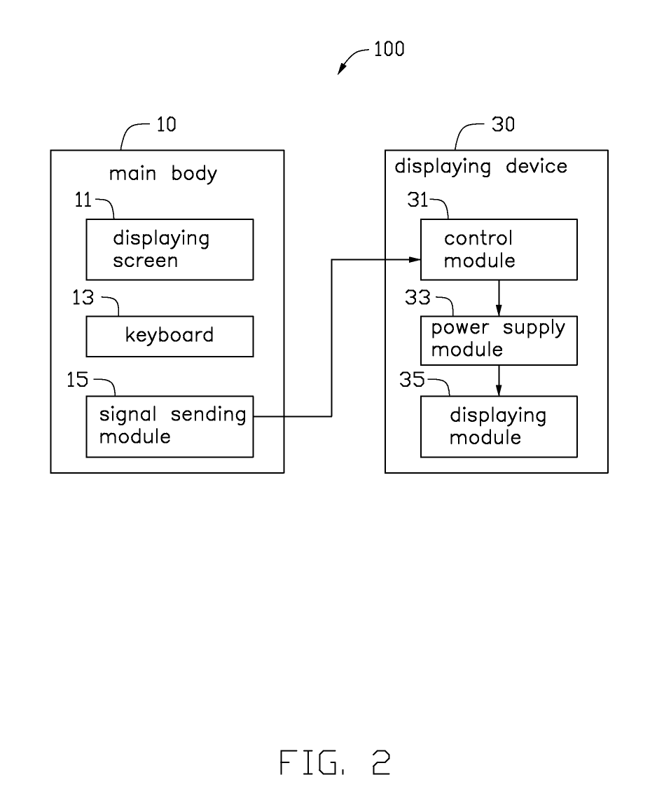

FIG. 1 and FIG. 2 illustrate an embodiment of an electronic device 100. The electronic device 100 includes a main body 10 and a displaying device 30 located on the main body 10. In at least one embodiment, the electronic device 100 can be a notebook computer.

The main body 10 includes a display screen 11 and a keyboard 13. The displaying device 30 can be located on edges of the display screen 11 (see FIG. 1) or located on the keyboard 13 (not shown). A signal sending module 15 can be located in the main body 10 and is configured to send a first signal and a second signal according to the environment that the electronic device 100 is located. For example, when the electronic device 100 is located in a dark environment, the signal sending module 15 can detect the dark environment to send the first signal to displaying module 30; when the electronic device 100 is located in a bright environment, the signal sending module 15 can detect the bright environment to send the second signal to displaying module 30. In at least one embodiment, the first signal is a high level signal, and the second signal is a low level signal.

The displaying device 30 includes a control module 31, a power supply module 33, and a display module 35 coupled to the power supply module 33. The control module 31 is configured to receive the first signal allowing the power supply module 33 to supply power to the display module 35, thereby the display module 35 can be illuminated. The control module 31 is also configured to receive the second signal allowing the power supply module 33 to stop supplying power to the display module 35, thereby the display module 35 is not illuminated. In at least one embodiment, the display module 35 includes at least one light emitting diode.

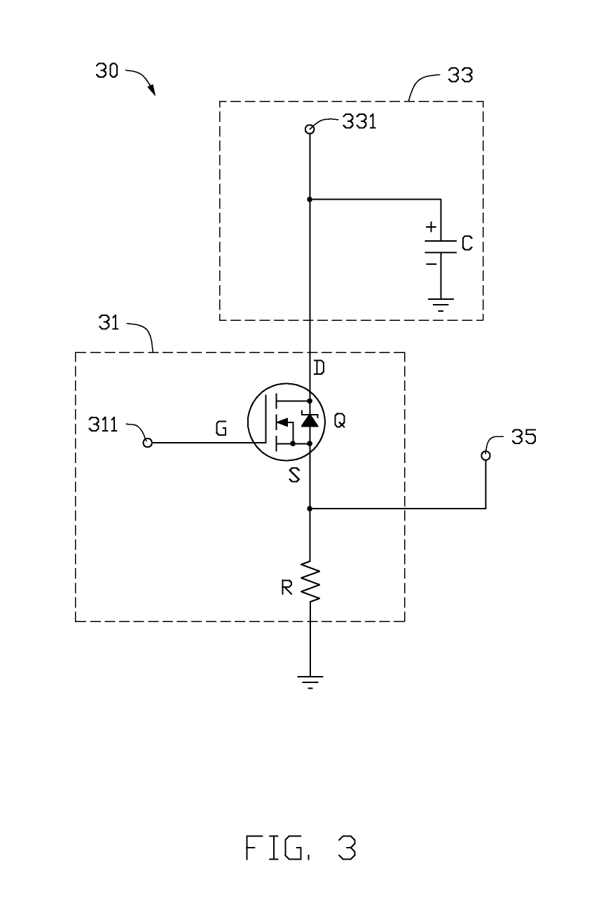

FIG. 3 illustrates an embodiment of the display module 30 of the electronic device 100 of FIG. 1. The control module 31 includes a receiving terminal 311, a field-effect tube (FET) D and a resistor R. The receiving terminal 311 is configured to receive the first signal or the second signal sent to the FET D. The FET D is switched on when the first signal is received, thereby the power supply module 33 supplies power to the display module 35. The FET D is switched off when the second signal is received; thereby the power supply module 33 stops supplying power for the display module 35. A first terminal of the resistor R is coupled to the FET D and the display module 35, and a second terminal of the resistor R is grounded. In at least one embodiment, the FET D is an N type FET.

The power supply module 33 includes a power supply 331 and a capacitor C. A positive pole of the capacitor C is coupled to the power supply 331, and a negative pole of the capacitor C.

In use, the electronic device 100 is powered on. The signal sending module 15 sends the first signal or the second signal to the displaying device 30. When the electronic device 100 is located on a dark environment, the signal sending module 15 can detect the dark environment to send the first signal to the FET D, the FET D is switched on, thereby the power supply module 33 supplies power to the display module 35 and the display module 35 is illuminated. When the electronic device 100 is located in a bright environment, the signal sending module 15 can detect the bright environment to send the second signal to the FET D, the FET D is switched off when the second signal is received, thereby the power supply module 33 stops supplying power to the display module 35.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, especially in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. A displaying device comprising:
a control module;
a power supply module; and
a displaying module coupled to and powered by the power supply module;
wherein, the control module is configured to receive a first signal and a second signal;
wherein, upon receipt of the first signal, the control module allows the power supply module to supply power to the displaying module; and
wherein, upon receipt of the second signal, the control module stops the power supply module from supplying power to the displaying module.

2. The displaying device of claim 1, wherein the control module comprises a field-effect tube, the field-effect tube is configured to switch on when received the first signal for allowing the power supply module for supplying power for the displaying module, and the field-effect tube is configured to switch off when received the second signal for allowing the power supply module for stopping supplying power for the displaying module.

3. The displaying device of claim 2, wherein the field-effect tube is N type field-effect tube.

4. The displaying device of claim 1, wherein the first signal is a high level signal, and the second signal is a low level signal.

5. The displaying device of claim 1, wherein the displaying module further comprises at least one light emitting diode.

6. The displaying device of claim 1, wherein the control module further comprises a resistor, and the resistor is coupled to the displaying module.

7. The displaying device of claim 1, wherein the power supply module comprises a power supply and a capacitor, a positive pole of the capacitor is coupled to the power supply, and a negative pole of the capacitor is grounded.

8. An electronic device comprising:
a main body; and
a displaying device located on the main body and comprising:
a control module;
a power supply module; and
a displaying module coupled to the power supply module;
wherein the main body is configured to send a first signal or a second signal to the control module, the control module is configured to receive the first signal to allow the power supply module for supplying power for the displaying module, and the control module is also configured to receive a second signal to allow the power supply module for stopping supplying power for the displaying module.

9. The electronic device of claim 8, wherein the main body comprises a displaying screen, the displaying module is located on edges of the displaying screen.

10. The electronic device of claim 8, wherein the control module comprises a field-effect tube, the field-effect tube is configured to switch on when received the first signal for allowing the power supply module for supplying power for the displaying module, and the field-effect tube is configured to switch off when received the second signal for allowing the power supply module for stopping supplying power for the displaying module.

11. The electronic device of claim 10, wherein the field-effect tube is N type field-effect tube.

12. The electronic device of claim 8, wherein the first signal is a high level signal, and the second signal is a low level signal.

13. The electronic device of claim 8, wherein the displaying module comprises at least one light emitting diode.

14. The electronic device of claim 8, wherein the control module further comprises a resistor, and the resistor is coupled to the displaying module.

15. The electronic device of claim 8, wherein the power supply module comprises a power supply and a capacitor, a positive pole of the capacitor is coupled to the power supply, and a negative pole of the capacitor is grounded.

16. The electronic device of claim 8, wherein the main body further comprises a signal sending module configured to send the first signal and the second signal according to the environment that the electronic device is located, when the electronic device is located in a dark environment, the signal sending module is configured to detect the dark environment to send the first signal to the control module; when the electronic device is located in a bright environment, the signal sending module is configured to detect the bright environment to send the control module.
